(19) United States
(12) Patent Application Publication
(10) Pub. No.: US 2026/0093707 A1
(43) Pub. Date: Apr. 2, 2026

(54) SEARCHING VECTOR EMBEDDINGS BASED ON CONTEXT RADIUS

(71) Applicant: View Systems, Inc., Dover, DE (US)

(72) Inventors: Blake Martz, San Diego, CA (US); Joel Christner, El Dorado Hills, CA (US)

(21) Appl. No.: 19/347,363

(22) Filed: Oct. 1, 2025

Related U.S. Application Data
(60) Provisional application No. 63/702,599, filed on Oct. 2, 2024.

(51) Int. Cl. G06F 16/2458; G06F 16/22

(52) U.S. Cl. CPC G06F 16/2462; G06F 16/2237

(57) ABSTRACT

This disclosure provides methods, devices, and systems for data retrieval. The present implementations more specifically relate to techniques for searching vector embeddings based on contextual information. In some aspects, a data retrieval system may receive a search query including a search value and a context radius indicating a number (N) of terms representing a range of contextual information. The data retrieval system retrieves, from a vector repository storing vector embeddings associated with a data asset, a number (K) of vector embeddings that match the search value (such as based on cosine similarity, Euclidean distance, or other similarity measure). The data retrieval system further retrieves, from the vector repository, N additional vector embeddings for each of the K matching vector embeddings based on a hierarchy of terms associated with the data asset, where the hierarchy of terms indicates an ordinal position for each vector embedding relative to the data asset.

### CROSS-REFERENCE TO RELATED APPLICATIONS

This application claims priority and benefit under 35 U.S.C. § 119(e) to U.S. Provisional Patent Application No. 63/702,599, filed Oct. 2, 2024, which is incorporated herein by reference in its entirety.

### TECHNICAL FIELD

This disclosure relates generally to machine learning, and specifically to searching vector embeddings based on context radius.

### DESCRIPTION OF RELATED ART

Machine learning (also referred to as “artificial intelligence” or “AI”) is a technique for improving the ability of a computer system or application to perform a certain task. Machine learning can be generally broken down into two component parts: training and inferencing. During the training phase, a machine learning system is provided with one or more “answers” and a large volume of raw training data associated with the answers. The machine learning system analyzes the training data to learn a set of rules (also referred to as a machine learning “model”) that can be used to describe each of the answers. During the inference phase, the machine learning system may infer answers from new data using the learned set of rules.

Deep learning is a particular form of machine learning in which the inferencing and training phases are performed over multiple layers. Deep learning architectures are often referred to as “artificial neural networks” due to the manner in which information is processed (similar to a biological nervous system). For example, each layer of an artificial neural network may be composed of one or more “neurons.” Each layer of neurons may perform a different transformation on the output data from a preceding layer so that the final output of the neural network results in the desired inferences. The set of transformations associated with the various layers of the network is referred to as a “neural network model.”

Some neural networks are designed to process vectorized data, also referred to as “embeddings.” An embedding is a numerical vector, in any high-dimensional space, having a magnitude and direction that represents a real-world object (such as a word) or set of objects (such as a sentence, paragraph, or other grouping of words). Many generative AI applications are powered by large language models (LLMs) previously trained on a dataset to help craft responses to user prompts (or queries). Retrieval augmented generation (RAG) is a technique for enriching the answers produced by a language model with contextual information relevant to the user prompt. For example, RAG may leverage data in the form of graph, relational, vector, or virtually any consumable form, to enrich the response, improve the response, or serve as input to better guide the model on how to respond.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter.

One innovative aspect of the subject matter of this disclosure can be implemented in a method of data retrieval. The method includes steps of receiving a search query including a search value and a context radius indicating a number (N) of terms representing a range of contextual information; retrieving, from a vector repository storing a plurality of vector embeddings associated with a data asset, one or more vector embeddings of the plurality of vector embeddings that match the search value; and retrieving, from the vector repository, N additional vector embeddings of the plurality of vector embeddings for each matching vector embedding of the one or more matching vector embeddings based on a hierarchy of terms associated with the data asset.

Another innovative aspect of the subject matter of this disclosure can be implemented in a data retrieval system, including a processing system and a memory. The memory stores instructions that, when executed by the processing system, cause the data retrieval system to receive a search query including a search value and a context radius indicating a number (N) of terms representing a range of contextual information; retrieve, from a vector repository storing a plurality of vector embeddings associated with a data asset, one or more vector embeddings of the plurality of vector embeddings that match the search value; and retrieve, from the vector repository, N additional vector embeddings of the plurality of vector embeddings for each matching vector embedding of the one or more matching vector embeddings based on a hierarchy of terms associated with the data asset.

### BRIEF DESCRIPTION OF THE DRAWINGS

The present implementations are illustrated by way of example and are not intended to be limited by the figures of the accompanying drawings.

FIG. 1 shows a block diagram of an example data orchestration system, according to some implementations.

FIG. 2 shows a block diagram of an example data processing pipeline, according to some implementations.

FIG. 3 shows a block diagram of an example data management system, according to some implementations.

FIG. 4 shows a block diagram of an example data retrieval system, according to some implementations.

FIG. 5 shows an illustrative flowchart depicting an example operation for data retrieval, according to some implementations.

### DETAILED DESCRIPTION

In the following description, numerous specific details are set forth such as examples of specific components, circuits, and processes to provide a thorough understanding of the present disclosure. The term “coupled” as used herein means connected directly to or connected through one or more intervening components or circuits. The terms “electronic system” and “electronic device” may be used interchangeably to refer to any system capable of electronically processing information. Also, in the following description and for purposes of explanation, specific nomenclature is set forth to provide a thorough understanding of the aspects of the disclosure. However, it will be apparent to one skilled in the art that these specific details may not be required to practice the example implementations. In other instances, well-known circuits and devices are shown in block diagram form to avoid obscuring the present disclosure. Some portions of the detailed descriptions which follow are presented in terms of procedures, logic blocks, processing and other symbolic representations of operations on data bits within a computer memory.

These descriptions and representations are the means used by those skilled in the data processing arts to most effectively convey the substance of their work to others skilled in the art. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system. It should be borne in mind, however, that all of these and similar terms are to be associated with the appropriate physical quantities and are merely convenient labels applied to these quantities.

Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

In the figures, a single block may be described as performing a function or functions; however, in actual practice, the function or functions performed by that block may be performed in a single component or across multiple components, or may be performed using hardware, using software, or using a combination of hardware and software. To clearly illustrate this interchangeability of hardware and software, various illustrative components, blocks, modules, circuits, and steps have been described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example systems or devices may include components other than those shown, including well-known components such as a processor, memory and the like.

The techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium including instructions that, when executed, performs one or more of the methods described herein. The non-transitory processor-readable data storage medium may form part of a computer program product, which may include packaging materials.

The non-transitory processor-readable storage medium may comprise random access memory (RAM) such as synchronous dynamic random-access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, or executed by a computer or other processor.

The various illustrative logical blocks, modules, circuits and instructions described in connection with the implementations disclosed herein may be executed by one or more processors (or a processing system). The term “processor,” as used herein may refer to any general-purpose processor, special-purpose processor, conventional processor, controller, microcontroller, or state machine capable of executing scripts or instructions of one or more software programs stored in memory.

Aspects of the present disclosure may improve the quality and accuracy of generative AI applications (such as those that rely on RAG architectures) by leveraging the organizational hierarchy of constituent data segments, which are commonly organized into semantic cells (broader collections of data, generally within a document) and semantic chunks (more granular pieces of data within a cell). More specifically, by leveraging the inferred or explicit organization of cells and chunks, and a context radius for expanding a vector search, aspects of the present disclosure may provide additional context that can be used to enrich and inform the responses generated by an AI application in response to user prompts or queries.

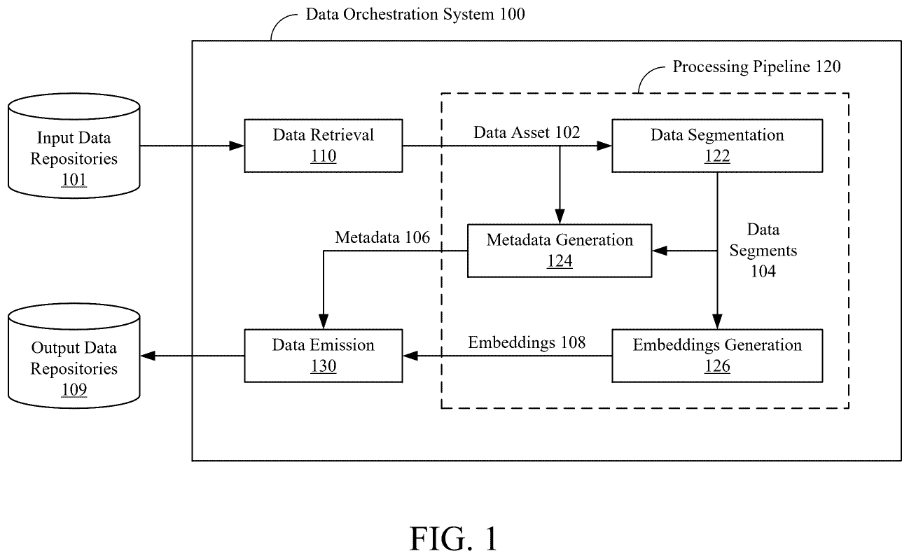

FIG. 1 shows a block diagram of an example data orchestration system 100, according to some implementations. The data orchestration system 100 is configured to retrieve data assets 102 from one or more input data repositories 101, convert each data asset 102 to a respective set of embeddings 108, and emit the resulting embeddings 108 to one or more output data repositories 109. In some aspects, the data orchestration system 100 may further generate metadata 106, to be stored with the embeddings 108 (such as in the same or parallel repository), based on the received data assets 102. A data asset 102 can be a document, file, or database of any type (such as images, videos, slideshow presentations, word processing documents, SQL databases, JavaScript Object Notation (JSON) files, and HyperText Markup Language (HTML) documents, among other examples). In some implementations, the output data repositories 109 may be different than the input data repositories 101. In some other implementations, the output data repositories 109 may be the same as the input data repositories 101.

The data orchestration system 100 includes a data retrieval component 110, a data processing pipeline 120, and a data emission component 130. The data retrieval component 110 is configured to communicate or interface with the input data repositories 101 to facilitate the retrieval of data assets 102. Example suitable input data repositories 101 include computers, servers, storage systems, and third-party platforms (such as software-as-a-service (SaaS) platforms), among other examples. In some implementations, the data retrieval component 110 may store information identifying one or more input data repositories 101 from which the data assets 102 can be retrieved. In some implementations, the data retrieval component 110 may detect or identify the input data repositories 101 using network discovery tools (such as by querying Active Directory or performing port scans on the network).

The data processing pipeline 120 is configured to perform a number of data operations that transform the data asset 102 into the embeddings 108. More specifically, the data processing pipeline 120 may process the data asset 102 according to one or more data objectives and/or requirements of a processing system or application (such as a machine learning model) intended to consume the data asset 102. In some implementations, the data processing pipeline 120 may store a set of discrete data operations that can be used to construct a data flow. A data flow defines the order in which the data operations are performed, including which specific steps are taken given a successful step, a failed step, or a step that encounters an unrecoverable exception. The data operations may include open-source and/or closed-source libraries that are configured to perform discrete tasks against the data. Example suitable tasks include loading data from a file or database, extracting text, stemming or lemmatizing the text, obfuscation and redaction, and merging it with other data, among other examples.

In the example of FIG. 1, the data processing pipeline 120 is shown to include at least a data segmentation component 122, a metadata generation component 124, and an embeddings generation component 126. The data segmentation component 122 is configured to subdivide the data asset 102 into one or more data segments 104. In some implementations, the data segmentation component 122 may balance the granularity of the data segments 104 with the resource limitations of the data processing pipeline 120 and/or with the data objectives or requirements of the processing system or application intended to consume the data asset 102. For example, subdividing the data asset 102 into more data segments 104 of finer granularity may require more processing resources of the data processing pipeline 120 than subdividing the data asset 102 into fewer data segments 104 of coarser granularity.

The metadata generation component 124 is configured to generate metadata 106 associated with the data asset 102. The metadata 106 may include any information about the data asset 102 that may be relevant for further processing of the data segments 104 and/or consumption of the embeddings 108. In some implementations, the metadata 106 may describe a hierarchy, order, or arrangement of the data segments 104 in relation to the data asset 102 (and in relation to one another). For example, if the data asset 102 comprises a text string, “we are the champions,” and the data segmentation component 122 parses each word of the text string as an individual data segment 104, the metadata generation component 124 may produce metadata 106 indicating that the data segment “we” occurs first in the text string, the data segment “are” occurs second in the text string, the data segment “the” occurs third in the text string, and the data segment “champions” occurs fourth (or last) in the text string.

The embeddings generation component 126 is configured to generate the embeddings 108 based on the data segments 104. As described above, an embedding is a mapping of any discrete (or categorical) variable to a vector of continuous numbers (such as a floating-point number) in a high-dimensional space. The mapping between objects and embeddings is defined by the neural network model used to process the embeddings. In other words, different neural network models may map the same object to different vector embeddings (which may reside in different multidimensional spaces). Thus, in some implementations, the embeddings generation component 126 may generate the embeddings 108 based on an associated AI application and/or neural network model (such as an LLM).

The data emission component 130 is configured to communicate or interface with the output data repositories 109 to facilitate the storage or emission of the embeddings 108. Example suitable output data repositories 109 include computers, servers, storage systems, and/or third-party platforms that are connected or otherwise accessible to processing systems and/or applications configured to use or perform additional processing on the embeddings 108 (such as for analytics or machine learning). In some implementations, the data emission component 130 may emit the metadata 106 to be stored in association with the embeddings 108. For example, the embeddings 108 and the metadata 106 may be stored in a relational database (which may span one or more output data repositories 109) that maps each embedding 108 to its associated metadata 106.

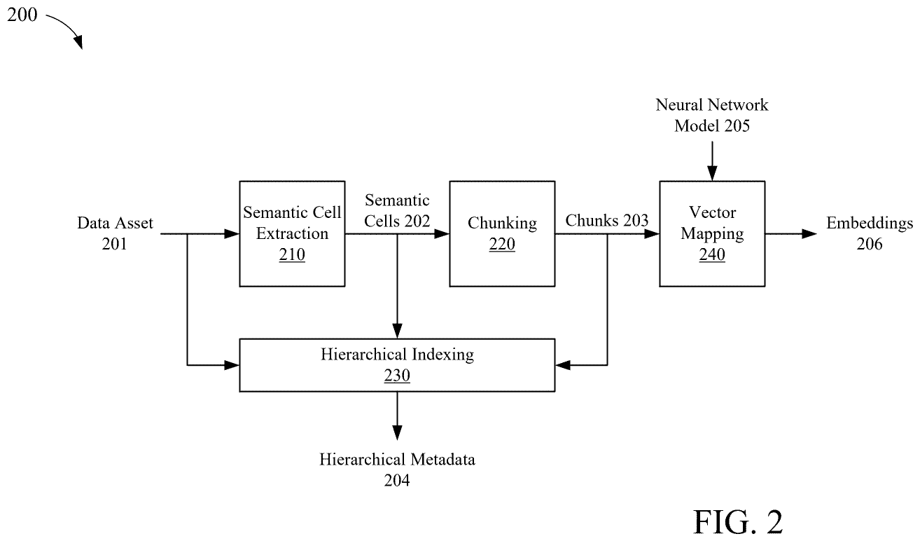

FIG. 2 shows a block diagram of an example data processing pipeline 200, according to some implementations. In some implementations, the data processing pipeline 200 may be one example of the data processing pipeline 120 of FIG. 1. More specifically, the data processing pipeline 200 is configured to transform a data asset 201 into a set of embeddings 206. With reference to FIG. 1, the data asset 201 and embeddings 206 may be examples of the data asset 102 and embeddings 108, respectively. In some implementations, the embeddings 206 may be associated with a neural network model 205. In other words, the data processing pipeline 200 may be configured to prepare the data asset 201 to be processed or consumed by the neural network model 205 or an AI application associated therewith.

Aspects of the present disclosure recognize that neural network models (including natural language processing (NLP) models and large language models (LLMs)) have predefined dimensionalities. In other words, a neural network model can only process and/or generate vector embeddings having a fixed size or dimension. As a result, the amount of input data represented by each vector embedding affects the fidelity of the neural network model. For example, mapping more input data to each vector embedding improves the efficiency of the training and/or inferencing operations but reduces the fidelity of the results. On the other hand, mapping less input data to each vector embedding sacrifices efficiency of the training and/or inferencing operations to improve the fidelity of the results. Thus, in some implementations, the data processing pipeline 200 may subdivide the data asset 201 into one or more data segments (such as the data segments 104 of FIG. 1) having a predetermined granularity based, at least in part, on the dimensionality of the neural network model 205. More specifically, the granularity of the data segments may balance the efficiency of the training and/or inferencing operations with the fidelity of the neural network model 205.

The data processing pipeline 200 includes a semantic cell extraction component 210, a chunking component 220, a hierarchical indexing component 230, and a vector mapping component 240. The semantic cell extraction component 210 is configured to parse or arrange the data in the data asset 201 into one or more semantic cells 202. As used herein, the term “semantic cell” refers to a grouping of data that is semantically related. Example suitable semantic cells include sentences, paragraphs, pictures, and/or slides. A semantic cell can also be a “child” of another semantic cell (such as a sentence within a paragraph). The chunking component 220 is configured to arrange the data within each semantic cell 202 into even more granular chunks 203. As used herein, the term “chunk” refers to a subgrouping of data that is related to a given semantic cell. For example, chunks may be used to break down a semantic cell into smaller groups of data that can be processed more efficiently by a machine or computer (such as an LLM or NLP model) or yield more accurate and/or precise results.

The hierarchical indexing component 230 is configured to generate hierarchical metadata 204 indicating a relative arrangement of the semantic cells 202 and the data chunks 203 with respect to the data asset 102. With reference to FIG. 1, the hierarchical metadata 204 may be one example of the metadata 106. More specifically, the hierarchical indexing component 230 may assign an index and/or other identifier(s) to each semantic cell 202 indicating the ordinal position of the semantic cell in relation to the data asset 201 and/or to other semantic cells 202 within the data asset 201. Similarly, the hierarchical indexing component 230 also may assign an index and/or other identifier(s) to each data chunk 203 indicating the ordinal position of the data chunk in relation to the underlying semantic cell 202 and/or to other data chunks 203 within the data asset 202.

As a simplified example, the semantic cell extraction component 210 may be configured to bifurcate each data asset 201 into a pair of semantic cells 202 and the chunking component 220 may be configured to parse each word within a semantic cell 202 as a respective data chunk 203. Thus, continuing the example of FIG. 1, where a data asset 210 includes the text string “we are the champions,” the semantic cell extraction component 210 may subdivide the data asset 201 into a first semantic cell “we are” and a second semantic cell “the champions.” Further, the chunking component 220 may subdivide the first semantic cell into data chunks “we” and “are” and may subdivide the second semantic cell into data chunks “the” and “champions.” In this example, the hierarchical indexing component 230 may generate hierarchical metadata 204 indicating that the semantic cell “we are” occurs first in the underlying data asset, the semantic cell “the champions” occurs second in the underlying data asset, the data chunk “we” occurs first in the underlying semantic cell, the data chunk “are” occurs second in the underlying semantic cell, the data chunk “the” occurs first in the underlying semantic cell, and the data chunk “champions” occurs second in the underlying semantic cell.

The vector mapping component 240 is configured to map each of the data chunks 203 to a respective embedding 206. In some implementations, the vector mapping component 240 may perform the mapping based, at least in part, on a neural network model 205. For example, the data chunks 203 may be passed or otherwise processed through one or more embeddings layers of the neural network model 205 having outputs that result in the embeddings 206. In some implementations, the embeddings 206 may be stored in a vector repository or relational database that also stores the semantic cells 202, the data chunks 203, and the hierarchical metadata 204. For example, the semantic cells 202, data chunks 203, hierarchical metadata 204, and embeddings 206 may be stored in a table or other data structure (across one or more data repositories) that maps or otherwise associates each of the embeddings 206 with the data chunk 203, semantic cell 202, and one or more components of the hierarchical metadata 204 associated therewith. Table 1 shows an example suitable data structure (with arbitrary information).

TABLE 1

| id | doc_id | cell_id | cell_position | chunk_id | chunk_position | content | embeddings |
|---|---|---|---|---|---|---|---|
| 1 | 1 | 1 | 1 | 1 | 1 | [ . . . ] | [0.1923776, . . . ] |
| 2 | 1 | 1 | 1 | 2 | 2 | [ . . . ] | [−0.663917, . . . ] |
| 3 | 1 | 1 | 1 | 3 | 3 | [ . . . ] | [0.2440195, . . . ] |
| 4 | 1 | 1 | 1 | 4 | 4 | [ . . . ] | [0.3001927, . . . ] |
| 5 | 1 | 1 | 1 | 5 | 5 | [ . . . ] | [−0.198237, . . . ] |
| 6 | 1 | 2 | 2 | 1 | 1 | [ . . . ] | [0.9716467, . . . ] |
| 7 | 1 | 2 | 2 | 2 | 2 | [ . . . ] | [0.3001927, . . . ] |
| 8 | 1 | 2 | 2 | 3 | 3 | [ . . . ] | [−0.198237, . . . ] |
| 9 | 1 | 3 | 3 | 1 | 1 | [ . . . ] | [0.9716467, . . . ] |

With reference to Table 1: “id” may be a database row identifier; “doc_id” may be a document identifier which indicates the document to which the following data relates (since there may be multiple semantic cells referencing this identifier, the table may include multiple rows associated with the “doc_id” identifier); “cell_id” may be an identification number for a particular semantic cell (since each semantic cell may have multiple chunks, the table may include multiple rows associated with the “cell_id” identifier); “cellposition” may indicate the ordinal position of a semantic cell within a data asset; “chunk_id” may identify each particular chunk within a semantic cell (this value may be unique for a given semantic cell); “chunkposition” indicates the ordinal position of the chunk within a semantic cell; “content” may include the original source content (such as words, characters, or values) of the associated chunk; and “embeddings” may be the vector representation of the contents of each data chunk.

The hierarchical metadata 204 may enhance the quality and/or accuracy of many AI applications, particularly those that rely on searching vector embeddings for contextual information (such as generative AI architectures that implement LLMs and RAG). For example, an AI “chatbot” may simulate human conversation by processing user queries (also referred to as “prompts”) through an LLM which infers a response (also referred to as a “completion”) to the user query. The knowledge base of the LLM may be limited to the data on which it was trained. However, RAG architectures can expand that knowledge base by providing additional contextual information that can be used by the LLM to infer the completion. For example, the RAG pipeline may search one or more vector repositories for relevant information associated with the prompt (based on cosine similarity and/or distance) to supply the LLM with additional context.

Existing RAG architectures are configured to provide a number (K) of the highest search results as contextual information for the LLM. However, aspects of the present disclosure recognize that materially relevant information from the same semantic concept may be spread across multiple chunks and/or semantic cell boundaries. As a result, some materially relevant information may not be included in the K highest search results. By storing the embeddings 206 with the hierarchical metadata 204, aspects of the present disclosure can capture such materially relevant information by specifying a “context radius” for the search. As used herein, the term “context radius” refers to a range of additional data to be retrieved in relation to any particular embedding 206. For example, given a context radius of size N, the RAG pipeline may retrieve the N embeddings (or data segments) that immediately precede a given embedding according to the hierarchical metadata 204 and/or the N embeddings (or data segments) that immediately follow the given embedding according to the hierarchical metadata 204.

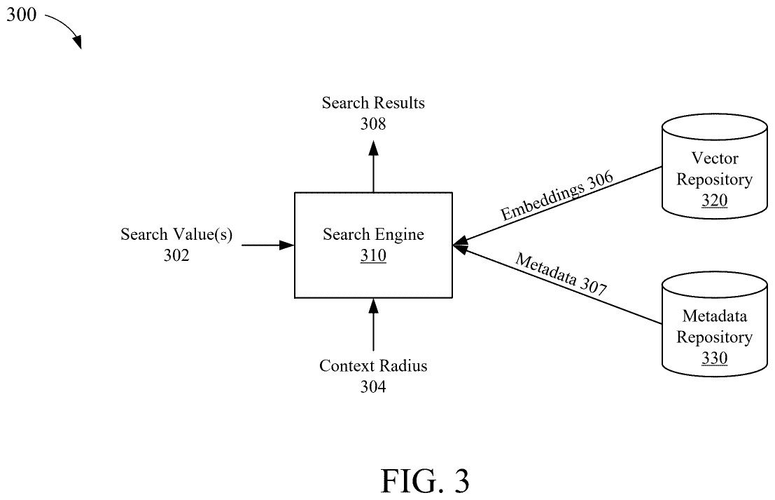

FIG. 3 shows an example data management system 300, according to some implementations. The data management system 300 includes a search engine 310, a vector repository 320, and a metadata repository 330. The vector repository 320 is configured to store embeddings 306. In some implementations, the embeddings 306 may examples any of the embeddings 108 and 206 of FIGS. 1 and 2, respectively. The metadata repository 330 is configured to store metadata 307 associated with the embeddings 306. For example, the metadata repository 330 may be linked to the vector repository 320 via one or more relational databases (such as Table 1, above) and/or other data structures. In some implementations, the metadata 307 may be one example of the metadata 106 of FIG. 1 or the hierarchical metadata 204 of FIG. 2 (an example of which is depicted in Table 1). Although only two data repositories are depicted in the example of FIG. 3, the data management system 300 may include additional data repositories (such as graph repositories) in some other implementations.

The search engine 310 is configured to search the vector repository 320 for embeddings 306 matching one or more search values 302 and return one or more search results 308 including a number (K) of the highest-matching embeddings 306 as well as any additional embeddings 306 that may fall within a context radius 304 of each of the K embeddings. For example, the one or more search values 302 and the context radius 304 may represent a search query. More specifically, each of the search values 302 may be a respective vector embedding that can be compared to the embeddings stored in the vector repository 320. Thus, the search engine 310 can identify the matching embeddings 306 based on a similarity search (such as cosine similarity, Euclidean distance, or any other suitable similarity measure). In some implementations, the search engine 310 may determine which (if any) embeddings fall within the context radius 304 of a matching embedding 306 based on the metadata 307. With reference for example to Table 1, given a context radius 304 of size N=1, if the search engine 310 identifies the embedding associated with id=3 as one of the top K matches for the search values 302, the search engine may retrieve, from the vector repository 320, the embedding 306 associated with id=3 (as the matching embedding) as well as the embeddings 306 associated with id=2 and id=4 (as the neighboring chunks that reside within the context radius 304 of the matching embedding). Thus, the search results 308 may include up to 3*K*N embeddings in response to a given query. In some aspects, the search results 308 may present each of the K highest-matching embeddings 306 in conjunction with its N nearest neighbors 306, for example, as a tuple.

In some implementations, the search results 308 may be ranked in order of similarity score. For example, the search engine 310 may rank the K matching embeddings 306 so that the embedding having the highest cosine similarity or shortest distance to the search value 302 is presented first, or with greater weight, in the search results 308 (along with its N nearest neighbors). In some other implementations, the search results 308 may be ranked based on the order indicated by the hierarchical metadata 307 (such as to preserve their original context). For example, the search engine 310 may group all embeddings associated with the same data asset and re-rank the embeddings within each group according to the order in which they occur in the underlying data asset. Each group may be assigned an overall ranking based on a statistical metric (such as mean, min, or max) associated with the similarity scores for each of the embeddings in the group. As a result, groups of embeddings with higher average (or max) scores may be presented earlier, or with greater weight, in the search results 308 and, within each group, embeddings that occur earlier in the underlying data asset may be presented earlier, or with greater weight, along with their N nearest neighbors even if such embeddings have a lower similarity score than other embeddings belonging to the same group. In some aspects, the ranking of the search results 308 may be dynamically toggled by a user or host of the data management system 300.

In some implementations, the directionality of the context radius 304 may be configurable (such as by a user or host of the data management system 300). As used herein, the term “directionality” refers to the direction in which the search engine 310 attempts to retrieve the N neighboring embeddings (given a context radius 304 of size N). In some implementations, the search engine 310 may retrieve only the N embeddings that immediately precede a matching embedding as indicated by the metadata 307. In some other implementations, the search engine 310 may retrieve only the N embeddings that immediately follow a matching embedding as indicated by the metadata 307. Still further, in some implementations, the search engine 310 may retrieve the N embeddings immediately preceding, as well the N embeddings immediately following, a matching embedding as indicated by the metadata 307.

In some implementations, the search results 308 may be provided as contextual information to an LLM. By capturing the K highest-matching embeddings 306, as well as any additional embeddings within the context radius 304 of each of the K matching embeddings, the data management system 300 may significantly improve the quality and accuracy of inferences produced by the LLM. For example, unlike existing RAG architectures, retrieval based on context radius can capture materially relevant information spanning multiple chunks within a semantic cell or even across cell boundaries (such as where the matching embedding is located at the beginning or end of a semantic cell). In some aspects, the techniques described herein can be further expanded to capture materially relevant information spanning multiple documents or document boundaries (such as where the matching embedding is located at the beginning or end of a data asset) when the ingestion order of data is known. For example, the search results 308 can be used to generate a prompt for a neural network model (such as an LLM).

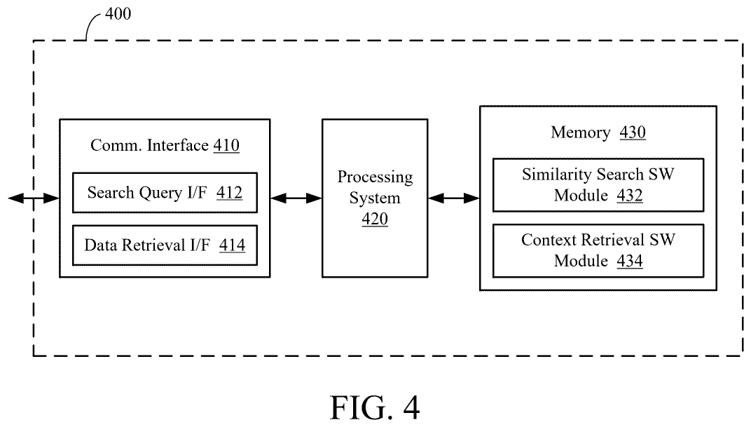

FIG. 4 shows a block diagram of an example data retrieval system 400, according to some implementations. In some implementations, the data retrieval system 400 may be one example of the search engine 310 of FIG. 3. More specifically, the data retrieval system 400 is configured to search one or more vector repositories for embeddings that match one or more search values (or search terms).

The data retrieval system 400 includes a communication interface 410, a processing system 420, and a memory 430. The communication interface 410 is configured to communicate with one or more data repositories and/or user interfaces. More specifically, the communication interface 410 includes a search query interface (I/F) 412 for communicating with one or more sources of user input (such as input devices, computing systems, or various other user interfaces) and a data retrieval interface (I/F) 414 for communicating with one or more data repositories (such as the vector repository 320 and/or the metadata repository 330 of FIG. 3). In some implementations, the search query interface 412 may receive a search query including a search value and a context radius indicating a number (N) of terms representing a range of contextual information.

The memory 430 includes a non-transitory computer-readable medium (including one or more nonvolatile memory elements, such as EPROM, EEPROM, Flash memory, or a hard drive, among other examples) that can store the following software (SW) modules: a similarity search SW module 432 to retrieve, from a vector repository storing a plurality of vector embeddings associated with a data asset, one or more vector embeddings of the plurality of vector embeddings that match the search value; and a context retrieval SW module 434 to retrieve, from the vector repository, N additional vector embeddings of the plurality of vector embeddings for each matching vector embedding of the one or more matching vector embeddings based on a hierarchy of terms associated with the data asset.

The processing system 420 includes any suitable one or more processors capable of executing scripts or instructions of one or more software programs stored in the data retrieval platform 400 (such as in the memory 430). For example, the processing system 420 can execute the similarity search SW module 432 to retrieve, from a vector repository storing a plurality of vector embeddings associated with a data asset, one or more vector embeddings of the plurality of vector embeddings that match the search value. The processing system 420 can also execute the context retrieval SW module 434 to retrieve, from the vector repository, N additional vector embeddings of the plurality of vector embeddings for each matching vector embedding of the one or more matching vector embeddings based on a hierarchy of terms associated with the data asset.

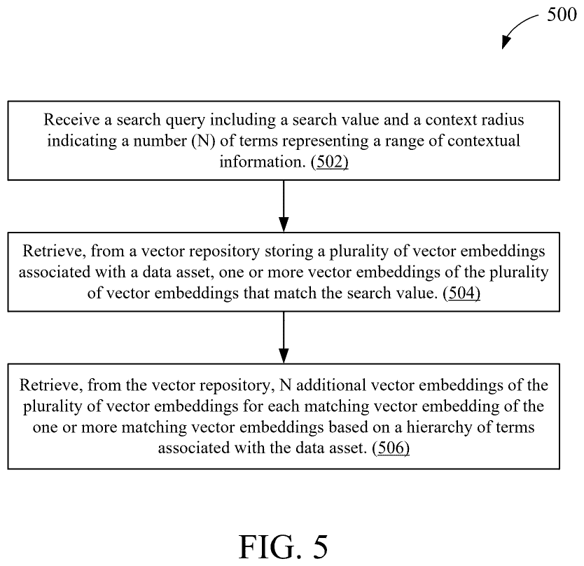

FIG. 5 shows an illustrative flowchart depicting an example operation 500 for data retrieval, according to some implementations. In some implementations, the example operation 500 may be performed by a data retrieval system such as the data retrieval system 400 of FIG. 4 or the search engine 310 of FIG. 3.

The data retrieval system receives a search query including a search value and a context radius indicating a number (N) of terms representing a range of contextual information (402). The data retrieval system retrieves, from a vector repository storing a plurality of vector embeddings associated with a data asset, one or more vector embeddings of the plurality of vector embeddings that match the search value (404). The data retrieval system further retrieves, from the vector repository, N additional vector embeddings of the plurality of vector embeddings for each matching vector embedding of the one or more matching vector embeddings based on a hierarchy of terms associated with the data asset (406). In some implementations, the data retrieval system may determine the hierarchy of terms based on metadata stored in a metadata repository associated with the vector repository.

In some aspects, the hierarchy of terms may indicate an ordinal position for each of the plurality of vector embeddings relative to the data asset. In some implementations, the retrieving of the N additional vector embeddings for each matching vector embedding may include determining the ordinal position for the matching vector embedding and determining the N additional vector embeddings based on the ordinal position of the matching vector embedding. In some implementations, the ordinal positions of the N additional vector embeddings may immediately precede the ordinal position for the matching vector embedding. In some other implementations, the ordinal positions for the N additional vector embeddings may immediately follow the ordinal position of the matching vector embedding. Still further, in some implementations, the ordinal positions for a number (M) of the additional vector embeddings may immediately precede the ordinal position of the matching vector embedding and the ordinal positions for the remaining M-N additional vector embeddings may immediately follow the ordinal position of the matching vector embedding.

In some aspects, the one or more matching vector embeddings may include a number (K) of highest-matching vector embeddings, among the plurality of vector embeddings, based on a similarity measure. In some implementations, the data retrieval system may further present each matching vector embedding of the K highest-matching vector embeddings as a tuple that includes the N additional vector embeddings associated therewith. In some implementations, the data retrieval system may further rank the K highest-matching vector embeddings based at least in part on the similarity measure. In some other implementations, the data retrieval system may further rank the K highest-matching vector embeddings based at least in part on their ordinal positions. In some aspects, the data retrieval system may further generate a prompt for a large language model (LLM) based at least in part on the K*N vector embeddings retrieved from the vector repository.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described herein. Whether such functionality is implemented in hardware or software depends upon the particular application and design constraints imposed on the overall system.

In the foregoing specification, implementations have been described with reference to specific examples thereof. It will, however, be evident that various modifications and changes may be made thereto without departing from the broader scope of the disclosure as set forth in the appended claims. The specification and drawings are, accordingly, to be regarded in an illustrative sense rather than a restrictive sense.

As used herein, a phrase referring to “at least one of” a list of items refers to any combination of those items, including single members. As an example, “at least one of: a, b, or c” is intended to cover: a, b, c, a-b, a-c, b-c, and a-b-c.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

What is claimed is:

1. A method of data retrieval, comprising:
receiving a search query including a search value and a context radius indicating a number (N) of terms representing a range of contextual information;
retrieving, from a vector repository storing a plurality of vector embeddings associated with a data asset, one or more vector embeddings of the plurality of vector embeddings that match the search value; and
retrieving, from the vector repository, N additional vector embeddings of the plurality of vector embeddings for each matching vector embedding of the one or more matching vector embeddings based on a hierarchy of terms associated with the data asset.

2. The method of claim 1, further comprising:
determining the hierarchy of terms based on metadata stored in a metadata repository associated with the vector repository.

3. The method of claim 1, wherein the hierarchy of terms indicates an ordinal position for each of the plurality of vector embeddings relative to the data asset.

4. The method of claim 3, wherein the retrieving of the N additional vector embeddings for each matching vector embedding comprises:
determining the ordinal position for the matching vector embedding; and
determining the N additional vector embeddings based on the ordinal position of the matching vector embedding.

5. The method of claim 4, wherein the ordinal positions for the N additional vector embeddings immediately precede the ordinal position of the matching vector embedding.

6. The method of claim 4, wherein the ordinal positions for the N additional vector embeddings immediately follow the ordinal position of the matching vector embedding.

7. The method of claim 4, wherein the ordinal positions for a number (M) of the additional vector embeddings immediately precede the ordinal position of the matching vector embedding and the ordinal positions for the remaining M-N additional vector embeddings immediately follow the ordinal position of the matching vector embedding.

8. The method of claim 3, wherein the one or more matching vector embeddings comprises a number (K) of highest-matching vector embeddings, among the plurality of vector embeddings, based on a similarity measure.

9. The method of claim 8, further comprising:
presenting each matching vector embedding of the K highest-matching vector embeddings as a tuple that includes the N additional vector embeddings associated therewith.

10. The method of claim 9, further comprising:
ranking the K highest-matching vector embeddings based at least in part on the similarity measure.

11. The method of claim 9, further comprising:
ranking the K highest-matching vector embeddings based at least in part on their ordinal positions.

12. The method of claim 8, further comprising:
generating a prompt for a large language model (LLM) based at least in part on the K*N vector embeddings retrieved from the vector repository.

13. A data retrieval system comprising:
a processing system; and
a memory storing instructions that, when executed by the processing system, causes the data retrieval system to:
receive a search query including a search value and a context radius indicating a number (N) of terms representing a range of contextual information;
retrieve, from a vector repository storing a plurality of vector embeddings associated with a data asset, one or more vector embeddings of the plurality of vector embeddings that match the search value; and
retrieve, from the vector repository, N additional vector embeddings of the plurality of vector embeddings for each matching vector embedding of the one or more matching vector embeddings based on a hierarchy of terms associated with the data asset.

14. The data retrieval system of claim 13, wherein execution of the instructions further causes the data retrieval system to:
determine the hierarchy of terms based on metadata stored in a metadata repository associated with the vector repository.

15. The data retrieval system of claim 13, wherein the hierarchy of terms indicates an ordinal position for each of the plurality of vector embeddings relative to the data asset.

16. The data retrieval system of claim 15, wherein the retrieving of the N additional vector embeddings for each matching vector embedding comprises:
determining the ordinal position for the matching vector embedding; and
determining the N additional vector embeddings based on the ordinal position of the matching vector embedding.

17. The data retrieval system of claim 15, wherein the one or more matching vector embeddings comprises a number (K) of highest-matching vector embeddings, among the plurality of vector embeddings, based on a similarity measure.

18. The data retrieval system of claim 17, wherein execution of the instructions further causes the data retrieval system to:
present each matching vector embedding of the K highest-matching vector embeddings as a tuple that includes the N additional vector embeddings associated therewith.

19. The data retrieval system of claim 18, wherein execution of the instructions further causes the data retrieval system to:
rank the K highest-matching vector embeddings based at least in part on the similarity measure.

20. The data retrieval system of claim 18, wherein execution of the instructions further causes the data retrieval system to:
rank the K highest-matching vector embeddings based at least in part on their ordinal positions.
